(19) United States
(12) Patent Application Publication
(10) Pub. No.: US 2013/0260747 A1
(43) Pub. Date: Oct. 3, 2013

(54) METHOD AND SYSTEM FOR MOBILE SET-UP OF FIXED PHONE'S CALLS

(71) Applicant: Isaac J. Labaton, Macabim (IL)

(72) Inventor: Isaac J. Labaton, Macabim (IL)

(73) Assignee: Isaac J. LABATON, Macabim (IL)

(21) Appl. No.: 13/125,797

(22) PCT Filed: Oct. 26, 2009
(86) PCT No.: PCT/IB2009/007424

§ 371 Date: Oct. 12, 2011

(30) Foreign Application Priority Data
Oct. 26, 2008 (IL) 194908

(51) Int. Cl. H04M 1/725

(52) U.S. Cl. CPC H04M 1/725
USPC 455/426.1; 455/554.2

(57) ABSTRACT

Methods are disclosed that incorporate the straightforwardness and the simplification of the steps and procedures that are used to set up calls using regular fixed phones including homes' phones, office's phones, public phones and PC's VoIP calls.

### CROSS REFERENCE TO RELATED APPLICATION

The present application is a U.S. national phase filing under 35 U.S.C. §371 of PCT/IB09/007424 filed 26 Oct. 2009 and claims priority from Israeli Patent Application No. 194908 filed on 26 Oct. 2008. The content of which is incorporated herein by reference.

### BACKGROUND OF THE INVENTION

A landline phone 104, main line or fixed-line phone 104 is a telephone that uses a line which travels through a solid medium, such as metal wire or optical fiber. Landline phones are distinguished from a mobile cellular phone 102, which uses electromagnetic waves.

As is known, the cellular 102 or mobile phone 102, referred hereafter as mobile 102, is lately replacing the fixed regular phone 104, which is referred hereafter as fixed phone 104. This trend is true for all categories of phones, including domestic phones, business phones (i.e. corporate/office phones), and public phones that are available in public areas such as the street.

Public phones are being used less and less. The calling card market, including the open credit calling accounts and the pre-paid or debit calling accounts, is shrinking month after month. It is anticipated that there will be a further reduction of non-cellular voice communication or fixed phone communication, except for Voice over Internet Protocol (VoIP), which no doubt will have a considerable portion of the voice communication market in the future.

One of the aims of the present invention is to ease this trend (using the mobile phone) or more precisely to show ways to, at least, attenuate, if not reverse the above mentioned trend that is affecting the fixed communications business. As will be described below, a method and system will be disclosed that has the potential to renew interest in using the fixed phone 104.

One of the existing factors which may contribute to attenuation of the above-mentioned trend is that a mobile phone radiates radiation which may be malignant for the user's health. Nevertheless, in spite of this risk or potential risk, people continue to use mobile phones more and more, due to many reasons, including the convenience of the mobile.

Another factor which may also contribute to attenuation of this trend, is the general public health risk implied in the mobile infrastructure. That is, the antennas' radiation may affect not only the mobile's user but the general public. Surely it may be that, in the near future, if the antennas' damage to the general public health becomes a widely accepted fact, then this factor will attenuate or reverse the trend.

A third factor that also acts against the use of the mobiles, is that instead of the regular fixed phone, the cost of usage of the mobile is a rate that is usually higher than the fixed phone. This may have a considerable effect on the caller's decision to place the next call using the mobile or the fixed phone.

Nevertheless, and in spite of all the good reasons pointing toward the contrary, people are using their mobiles more and more. Why? There are many reasons, including the fact that the mobile is so convenient, and has many additional features. Actually, the mobile may be much more than a phone and is often the unique personal gadget that we carry with us. It may be useful for completing transactions, for identification of the owner, for logical access to networks, for physical access to restricted places. In addition, it can be used as a personal computer, as a photo camera, as a MP3/MP4 player and many other uses in addition to be a phone.

In other words, we continue picking up the mobile each time we need to place a call, even though there may be a fixed phone that is available near by, with no radiation, at a lesser cost. Typically, in our cell phone we have stored our family's, friends' and colleagues' phone numbers. Thus, it is very convenient to use the mobile while pretending that this will be a short call, and the result is that one goes “cellular”, in spite of being perfectly aware that the correct decision should have been to pick up the fixed phone that is available near by.

One of the problems addressed by the present invention is to find a way to have the best of the mobile and the best of the fixed phone in the same call.

### SUMMARY OF THE INVENTION

In accordance with various aspects of the present invention, a method 105 is disclosed that incorporates the straightforwardness and the simplification of the steps and procedures that we use in order to set up calls using regular fixed phones including homes' phones, office's phones, public phones and PC's VoIP calls.

In accordance with an exemplary embodiment of the present invention, method 105 includes a software application 100 which runs in mobile 102 of the user 101. Software application 100 is also referred to in the following as the main application or soft-token 100.

In accordance with an exemplary embodiment of the present invention, method 105 may include a participating service company 109, and generally proceeds as follows:

The caller or user 101 (i.e., the person who places the call) picks up his/her mobile 102 and retrieves and launches the application 100. The user selects a destination number 110 that he would like to call, either from his mobile's phone-book 103 or alternatively caller 101 enters the destination number into mobile 102.

Caller 101 now places mobile 102 near the headset 128 of the available fixed phone 104 which includes a microphone 148.

Reference is now made to FIG. 6, which illustrates a typical setting up of a fixed-line 104 phone call that utilizes a mobile 102.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

User 101 presses a given button 106 in mobile 102 that activates application 100 in mobile 102. In accordance with an exemplary embodiment of the present invention, application 100 computes a string of digits 107 which includes the following: Service Company 109 access number 119; the user's login number (or equivalent), the token serial number or the user's identification 108 for access to the calling service provided by the participating service company 109 (participating Telecom); and the user's destination number 110.

With reference to FIG. 1, a typical string 107 is illustrated which comprises a participating telecom 109 service access number 119, the token identification 108 and the user destination number 110

It will be appreciated that the token identification may be made by means of the user login name or number, the token serial number, or other information that may be used to identify user 101.

In accordance with an exemplary embodiment of the present invention, the first part of string 107 (i.e., access number 119) is encoded to a dual-tone multi frequency (DTMF) signal 113. The last two parts of string 107 (i.e., login name or token identification 108; destination number 110) may also be encoded to sound using the standard acoustic DTMF technology or any other technology for encoding characters to sound 112. One possible technology for encoding characters to sound is disclosed in U.S. Pat. No. 6,236,724, hereby incorporated in its entirety.

In accordance with an exemplary embodiment of the present invention and with reference to FIGS. 2 and 3, a typical first part of string 107 is illustrated. String 107 is encoded to DTMF and includes participating service company access number 119.

In accordance with an exemplary embodiment of the present invention, application 100 encodes string 107 to acoustic sound waves 111. When user 101 places mobile 102 near headset 128 of fixed phone 104, the fixed phone 104 hears or captures acoustic sound waves 111 containing encoded string 107.

With continued reference to FIG. 3, the DTMF (first) portion 113 is transmitted to the switch 117. In accordance with an exemplary of the present invention, the first portion 113 of acoustic sound waves 111 contains the service company 109 access number 119 that is encoded using the DTMF acoustic standard. In accordance with an exemplary of the present invention, first portion 113 reaches, by means of a Local Telecom Company's network 116, an integral part of the public switched telephone network (PSTN), the nearest Switch 117.

Switch 117 decodes the DTMF signal 113 in accordance with standard procedures, as is performed for any regular call 118 placed through a regular land-line phone, such as fixed phone 104.

Now, Switch 117 has decoded the first portion 113 and determined the fixed phone call's destination number. In accordance with an exemplary embodiment of the present invention, the fixed phone call's destination number is the access-to-the-service phone number 119. The access-to-the-service is provided by the Participating Telecom or Service Company 109.

Next, Switch 117 sets up the call to access-to-the-service phone number 119.

With reference to FIG. 4, mobile 102 is illustrated in “voice contact” with the Participating Telecom Back-end System 123 in accordance with an exemplary embodiment of the present invention. That is, the sound generated by mobile 102 is heard or captured by system 123.

It will be appreciated that the sound does not arrive at system 123 as an acoustic sound signal, but rather as a digital electrical signal, into which the sound has been converted during the process of transmission.

Switch 117 connects fixed phone 104 with the Service Company's Private Branch Exchange (PBX) 120. This connection or call from fixed phone 104 to access number 119 will be referred to as the incoming call 127.

PBX 120 is also connected with a Service Company's Interactive Voice Response (IVR) system 121, and is also connected with a Service Company's Server 122 and databases 122.

In accordance with an exemplary embodiment of the present invention, Server 122 includes both the hardware and software components of the server. In addition, Service Company back-end System 123 or System 123 will be used to refer to the combination of PBX 120, IVR 121, and Server 122 including the server databases. System 123 captures the remaining portion of encoded string 111. That is, the encoded to sound string 111 minus the first portion 113.

In accordance with an exemplary embodiment of the present invention, this last portion includes the following: Soft-token 100 identification, or the user's login number and PIN (if any), or the caller's identification and authentication (if any) 108 for access to participating service company 109, and the caller's destination number 110.

Now, utilizing the soft-token ID or user's login number 108, system 123 retrieves and analyzes the soft-token or the user's account 124 and, consequently the credit status 125 of the caller 101 or of the soft-token 100. If soft-token 100 or the user 101 has enough credit and system 123 enables the user to go ahead, system 123, having received the third portion of the encoded string 111, can determine the user's destination number 110. Thus, System 123 places a call 126 to the user's destination number 110 and conferences both calls, the incoming call 127 and the outgoing call 126 from the System 123 to the user's destination number 110.

With reference to FIG. 9, a typical case of incoming call 127 in conference with an outgoing call 126 is illustrated in accordance with an exemplary embodiment of the present invention.

Stated another way, user 101 is now speaking with his destination number 110 through the fixed phone. However, it will be appreciated that what user 101 actually has done is a similar practice as the steps he should do, if he has placed a call with his mobile 102:

1.—In the beginning, user 101 picked up his mobile 102.

2.—User 101 pressed some mobile buttons 106 or selected a mobile icon that resulted in the launching of mobile's application 100.

3.—Use 101 selected the destination number from the mobile phone book or from the mobile's SIM, or otherwise, user 101 entered the destination number into mobile 102.

4.—User 101 places mobile 102 near headset 128 of fixed phone 104 and pressed the Send button in mobile 102.

5.—User 101 Speaks With His Destination Through the Fixed Phone.

With reference to FIG. 7, typical steps performed by user 101 in the process of setting up a call through fixed phone 104, by means of mobile 102 are illustrated in accordance with an exemplary embodiment of the present invention.

It will be appreciated that there is great similarity between these steps and the steps that user 101 would perform to set up a call through his mobile 102.

In addition, it is worth noting that user 101 never pressed any of fixed phone's 104 buttons.

With reference to FIG. 8, a typical usage of a hands-free or speaker-phone telephone 104 is illustrated in accordance with an exemplary embodiment of the present invention.

Therefore, it will be appreciated that there are not many differences between the experience of calling through the fixed phone and the experience of calling through the mobile. However, with respect to the user's health, user 101 has not used mobile 102 to communicate (that is, no exposure to radiation) and user 101 did not have to utilize the cellular antenna infrastructure. In addition, the call cost may be less than the mobile rate, as there is no air-time usage with a mobile phone.

Thus it will be appreciated that method 105 and application or soft-token 100 of the present invention will be welcomed by the general public, as they love their mobile phones, but would like to reduce the monthly billing and also reduce the radiation dose that the caller 101 is receiving from the mobile 102.

As a result, it will be appreciated that the extensive usage of this method will cause an increment on the fixed Telecom Companies' traffic at the expense of the cellular's traffic.

In accordance with an exemplary embodiment of the present invention, Stages for an exemplary implementation will be described.

An exemplary embodiment of the present invention includes:
a method 105,
a mobile's application 100, wherein the mobile application 100 is a software module or soft-token which may be in Java or ready for running in a Symbian mobile operation system, or in any other cellphone operation system,
and devices and software 123 for usage by the Participating Telecom Service Company referred to as: “the system 123”, and used in order to set up calls (incoming 127 and outgoing 126) through a fixed phone 104.

STAGE #1: Installation Stage

In accordance with an exemplary embodiment of the present invention, application 100 is downloaded in mobile 102 and is initialized by the user 101, entering the initial PIN 133. In accordance with one aspect of this embodiment, soft-token 100 may request the selection of a new application's PIN 134. Application 100 may already carry (embedded) the service company's user's login number 108 and user's system's PIN 135 or alternatively the account identification 124 or both.

Regular Operation Stages (For an Exemplary Embodiment)

STAGE #2: Retrieving the Soft-Token 100

During the regular operation of the mobile application 100, user 101 presses a given button 106 in mobile 102 or selects an icon, retrieving and launching application 100.

STAGE #3: Entering in the Mobile the Required Info.

Now, in accordance with an exemplary embodiment, application 101 may request from the user 101: selected PIN 134, and the destination number 110.

Destination number 110 may be retrieved from the mobile 102 phone's book 103, entered by the user 101, or retrieved from the service company 109 databases 123 at a later stage, by using a nickname 137, among other possibilities.

For example, if user 101 enters “Dentist”, the service company 109 knows that “Dentist”, for this particular user, is a pre-stored phone number 110 in their database.

In accordance with other embodiments, the destination number is pre-embedded in the application 100.

STAGE #4: Computation of the String and Encoding to Sound.

Now, application 100 computes a string of digits 107 that includes:

(1) the Service Company access number 119, which later is encoded to standard acoustic DTMF by application 100, and optionally is followed by a pause, and (2) the user's login number 108 and system PIN 135 or the user's 101 identification and authentication 108, or the soft-token account number, or any other information for access to the service 109, and (3) the destination number 110.

Wherein, in accordance with an exemplary embodiment of the present invention, the last two portions of string 107 may be encoded to sound using the standard acoustic DTMF or other technology for encoding to sound 112. One possible technology for doing that is disclosed in U.S. Pat. No. 6,724,114.

STAGE #5: Capturing, Converting from Sound to Electrical Waves

According to an exemplary embodiment, user 101 approaches the mobile 102 to the fixed phone 104 headset's microphone 148 or to the speaker (hands free) phone's microphone 148 and presses the “Call” button 106 or “SEND” 106 or selects an icon which further actuates the application 100. The application 100 encodes the string 107 to sound 111 as described in the stage 4 above.

In accordance with an exemplary embodiment of the present invention, soft-token 100 is an application able to capture and detect the fixed phone 104 dialing tone and use this detection as a trigger for generating the string 107 to sound waves 111, instead of the user's action.

The sound waves 111 are eventually captured by the fixed telephone microphone 148 as the voice is captured in any regular call. In accordance with an exemplary embodiment, the microphone 148 converts the sound on electromagnetic waves 141. The first portion of these waves 141, which is carrying the DTMF version of the access number 119 ultimately reaches the nearby PSTN's switch 117 traveling through the local telephone network 116 of the “fixed” Local Telephone Company 115.

STAGE #6: In the Local Telecom's Switch

The first portion 113 which was encoded using DTMF standards reaches the switch 117 first. This portion carries the participating service company access number information 119. This access number 119 may be a toll-free number. The switch 117 recuperates such information 119 and sets up a call to such number 119. This call is referred here as the incoming call 127. Now the fixed phone 104 is “vocally” connected to the participating service Telecom Company's system 123.

In accordance with an exemplary embodiment of the present invention, system 123 includes a PBX 120 which is also connected with a Service Company's Interactive Voice Response (IVR) 121 and is also connected with the Service Company's Servers and databases 122. As stated above, the PBX 120 in conjunction with the IVR 121 and the Servers, databases 122 will be referred collectively in the following as the Participating Telecom Service Company's back-end System 123, or System 123.

STAGE #7: The Incoming Call (From the Fixed Phone 104 to the System 123)

The switch 117 has connected the Participating Telecom's PBX 120 with the fixed phone 104.

Now, the rest of the sound waves 142 are converted to analog electrical waves 141 by the fixed telephone microphone 148, and which is carrying the rest of the string 107, reaches the system 123. Others embodiments can digitize the information, using no analog waves.

STAGE #8: The System 123 Sets up the Outgoing Call 126.

This System 123 captures the rest of the encoded string 111, (that is, 111 without the first portion 113)

The system 123 decodes such portion 142 recuperating the information about the user 101 or/and the user account 124 or the Soft-token account 143 according to various embodiments. Such information may include the user PIN 135 or the anonymous calling card account 143, or the pre-paid acoustic dedicated calling card 144 account 145, the conversation time limit 140, if any, and the information regarding the user's destination number 110, if it is no a dedicated soft-token in which case the fixed destination number 110 is received or retrieved from the database 123

Now the system 123 has received or retrieved from the databases 122 the relevant information required to determine if it should enable the phone conversation requested 126, which is the call from the system 123 to the user's destination 110 (the outgoing call 126)

If eventually the system 123 enables the outgoing call 126, it conferences both calls, incoming 127 and outgoing 126 and the user 101 is speaking with his destination number through the fixed phone 104 Reference is made to FIG. 9 which outlines both calls, on conference at the service company 109 back-end system 123.

### BRIEF DESCRIPTION OF THE DRAWINGS

A more complete understanding of the present invention may be derived by referring to the detailed description and claims when considered in connection with the Figures, where like reference numbers refer to similar elements throughout the Figures, and:

FIG. 1 illustrates a typical string 107 in accordance with an exemplary embodiment of the present invention;

FIG. 2 illustrates the first part of 107 encoded to DTMF 113 in accordance with an exemplary embodiment of the present invention;

FIG. 3 illustrates the transmission of the DTMF portion 113 to the PSTN local switch 117 in accordance with an exemplary embodiment of the present invention;

FIG. 4 illustrates the mobile 102 is in “voice contact” with the system 123 in accordance with an exemplary embodiment of the present invention;

FIG. 5 illustrates the outgoing call 126 in accordance with an exemplary embodiment of the present invention;

FIG. 6 illustrates the setting up of a fixed line phone 104 call by means of a mobile 104 in accordance with an exemplary embodiment of the present invention;

FIG. 7 illustrates the user 101 experience using the invention through a regular phone in accordance with an exemplary embodiment of the present invention;

FIG. 8 illustrates the user 101 experience using a hands-free phone in accordance with an exemplary embodiment of the present invention;

FIG. 9 illustrates typical incoming 127 and outgoing 126 calls in accordance with an exemplary embodiment of the present invention;

FIG. 10 illustrates using VoIP/internet network in accordance with an exemplary embodiment of the present invention;

FIG. 11 illustrates the detection of the Dial Tone by the Mobile and the consequential triggering of the first portion (DTMF) of the encoded message in accordance with an exemplary embodiment of the present invention; and

FIG. 12 illustrates the detection of the Triggering Tone by the Mobile and the consequential triggering of the second portion of the encoded message, which carries, amongst other, the accounting indicia or the destination number or both, in accordance with an exemplary embodiment of the present invention.

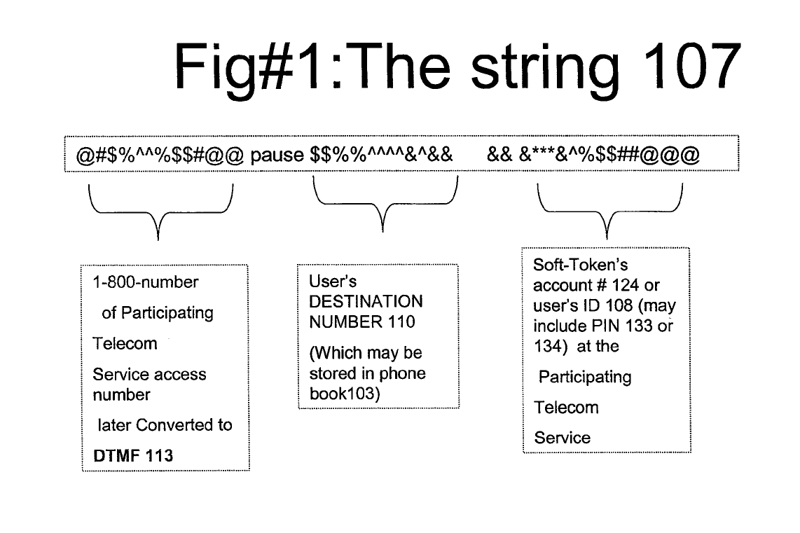

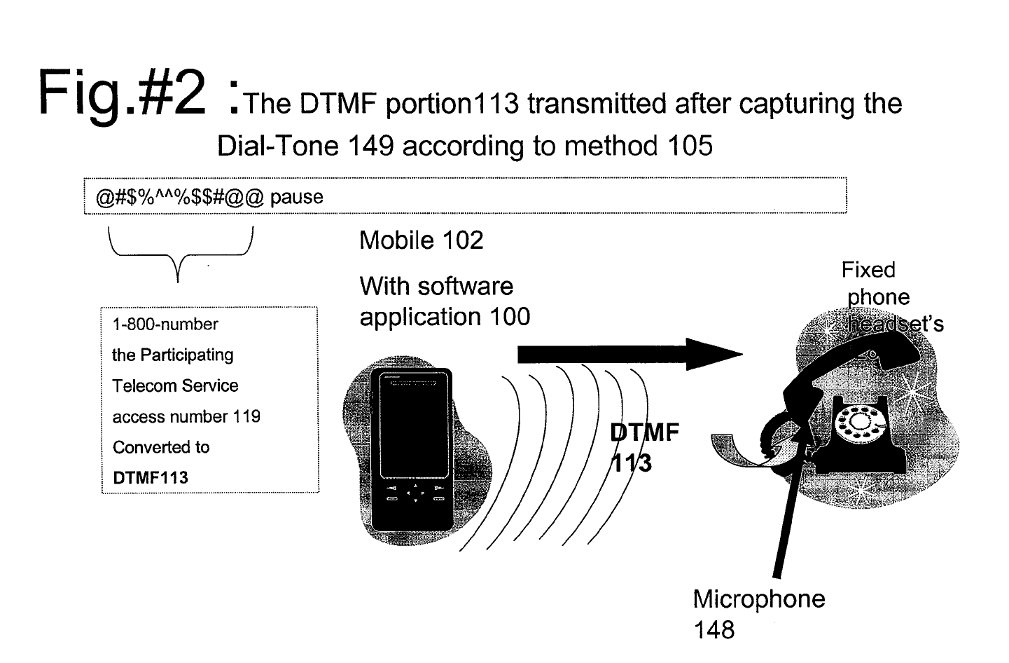

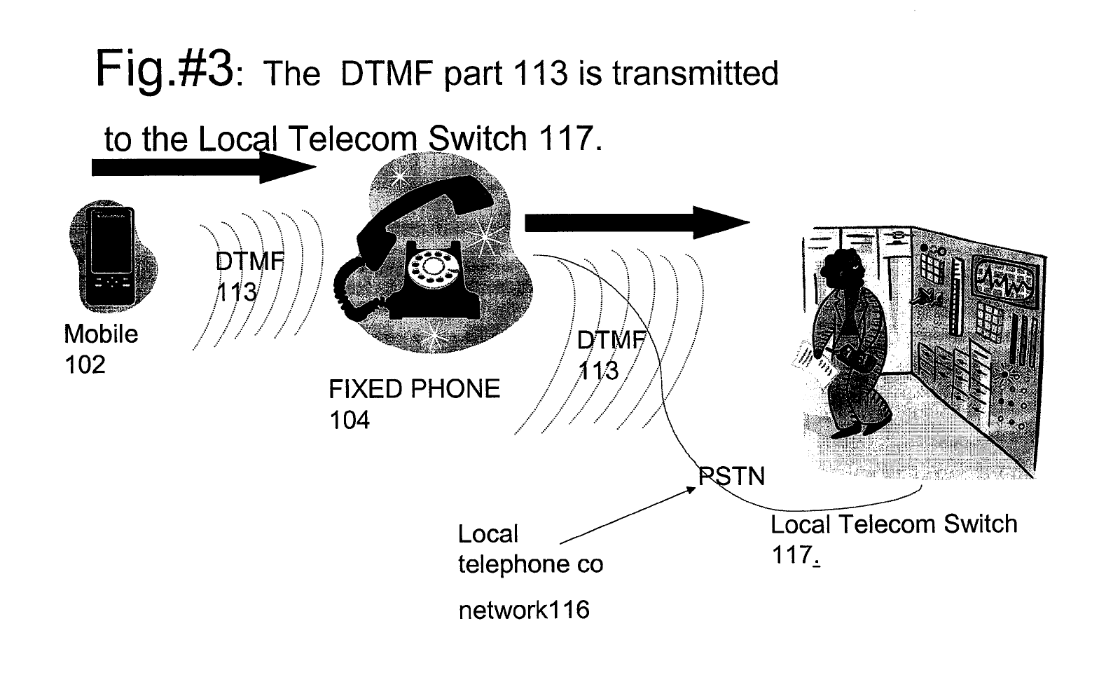

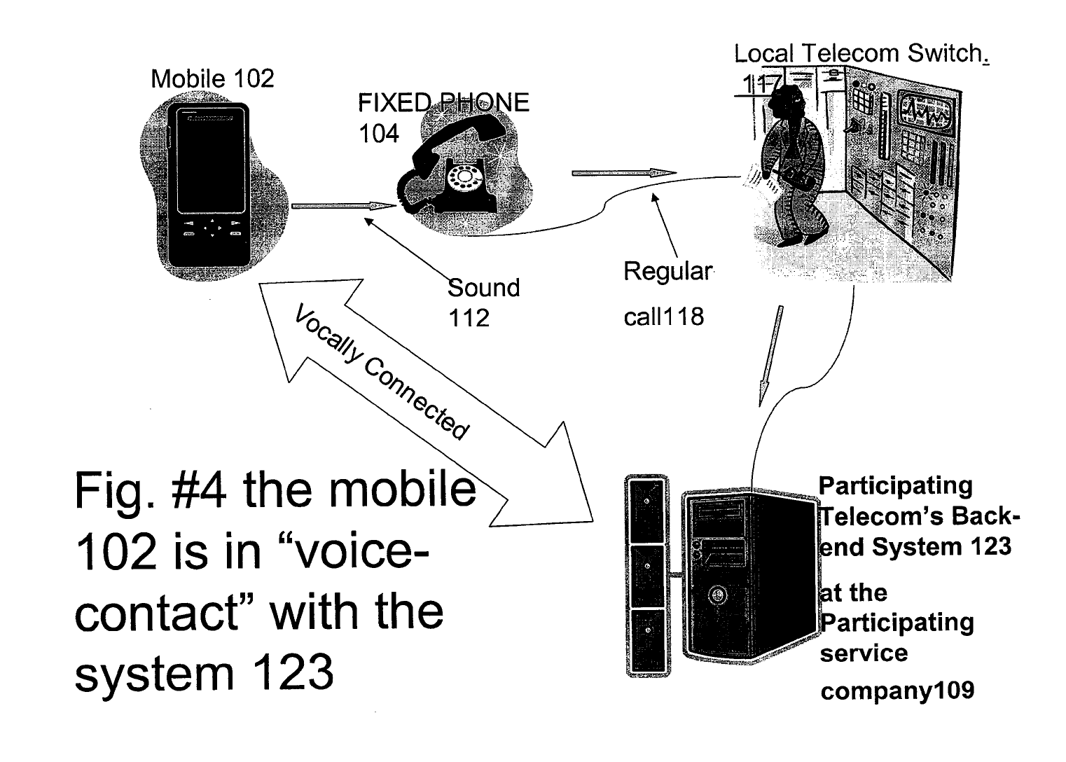

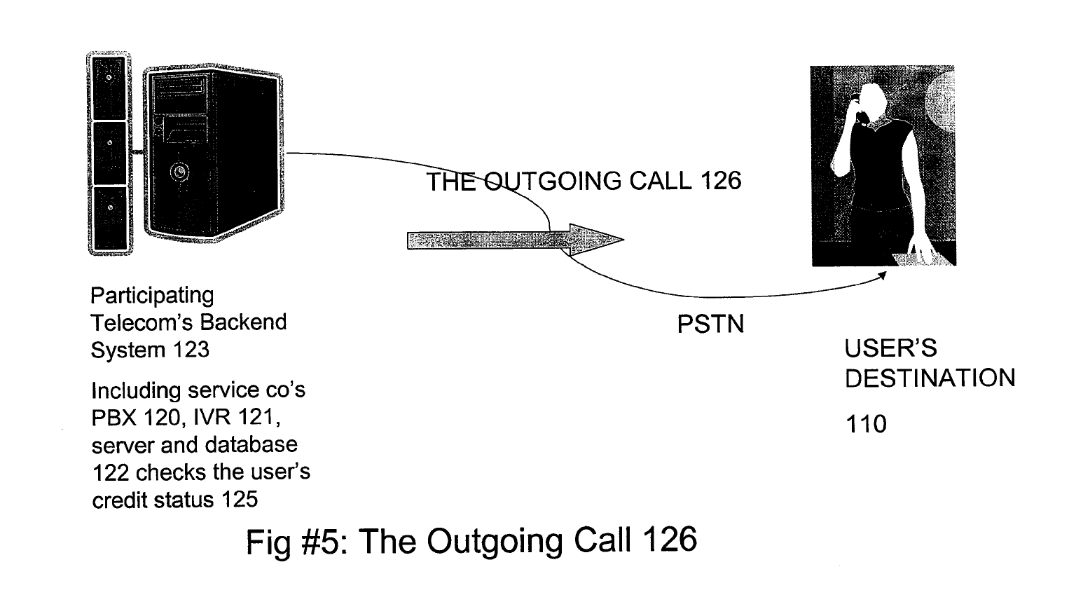

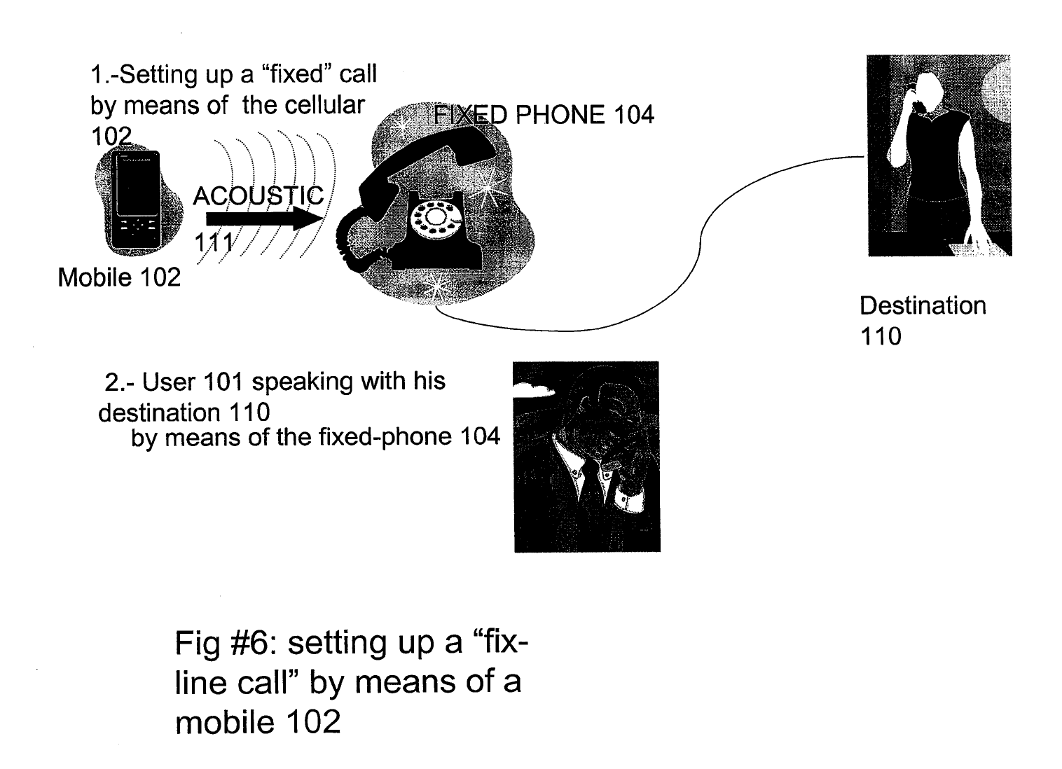

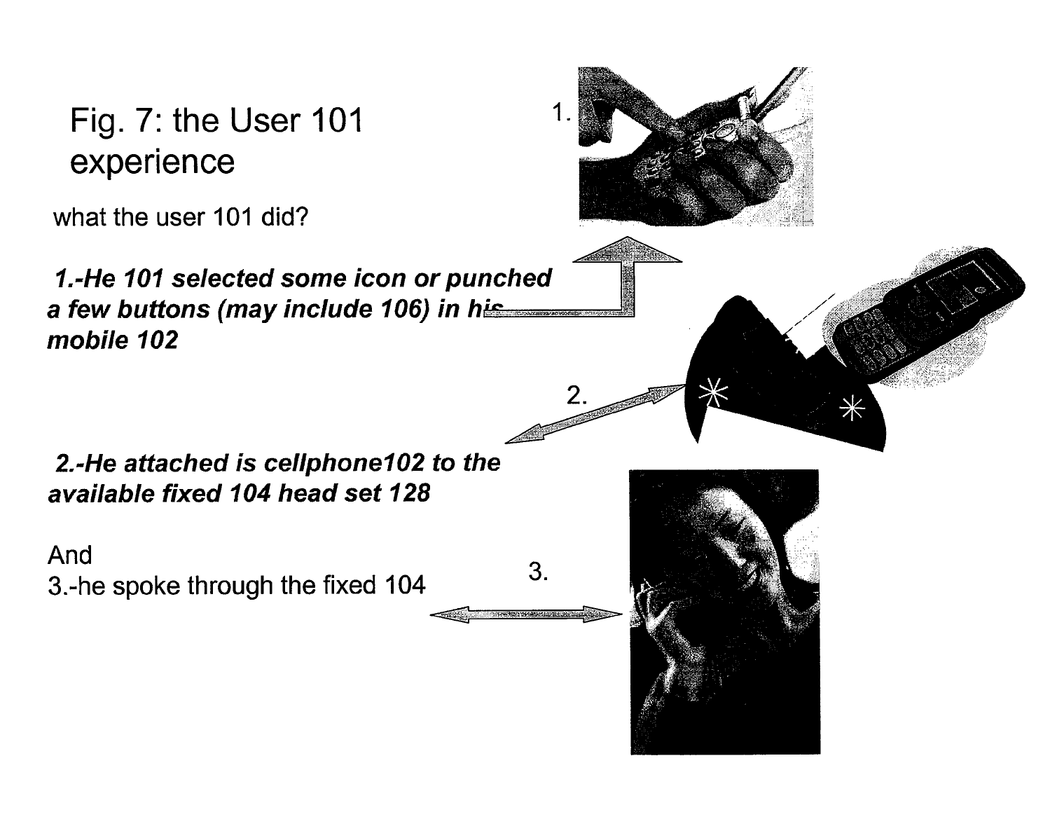

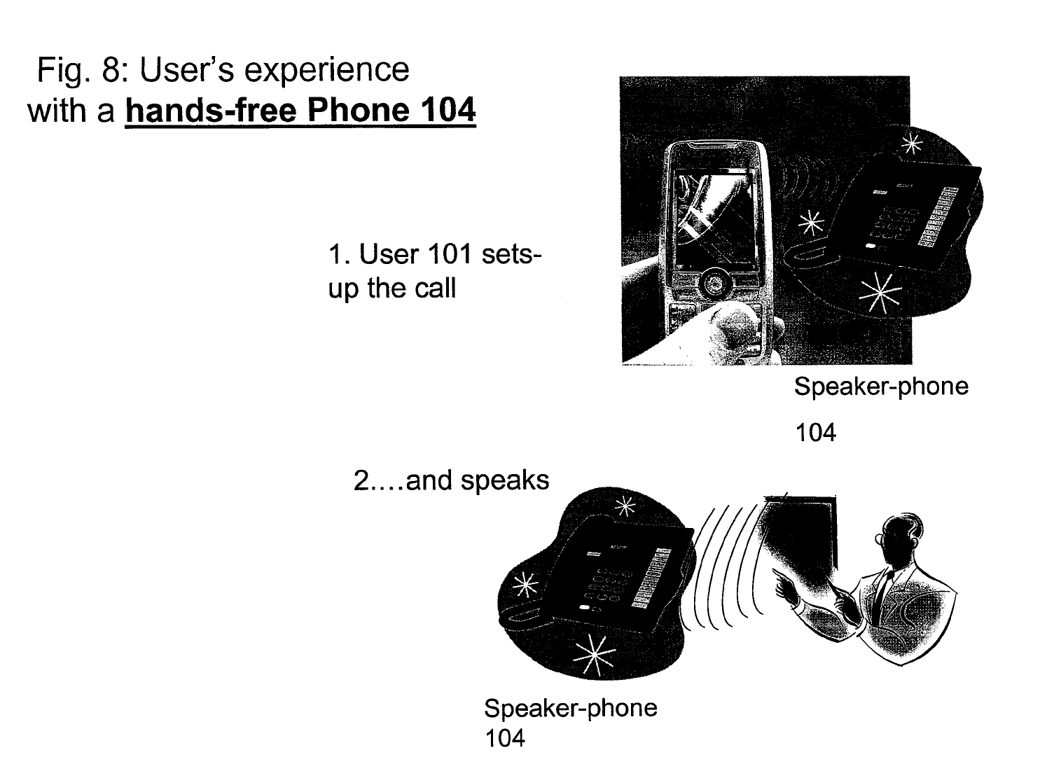

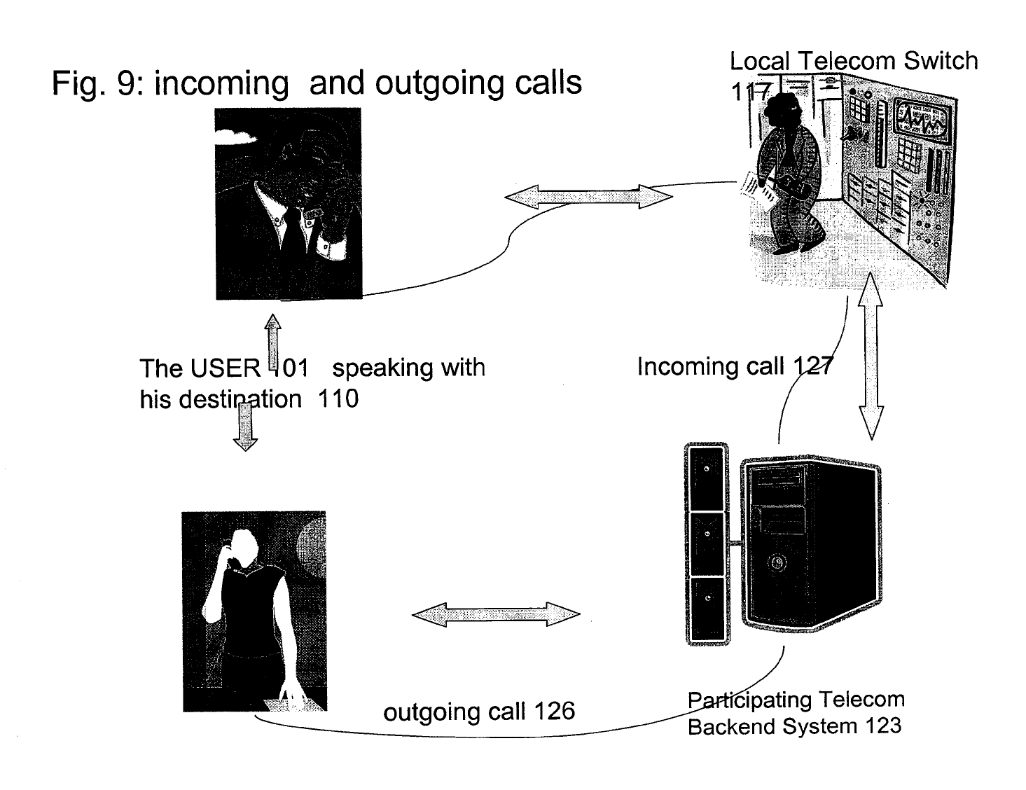

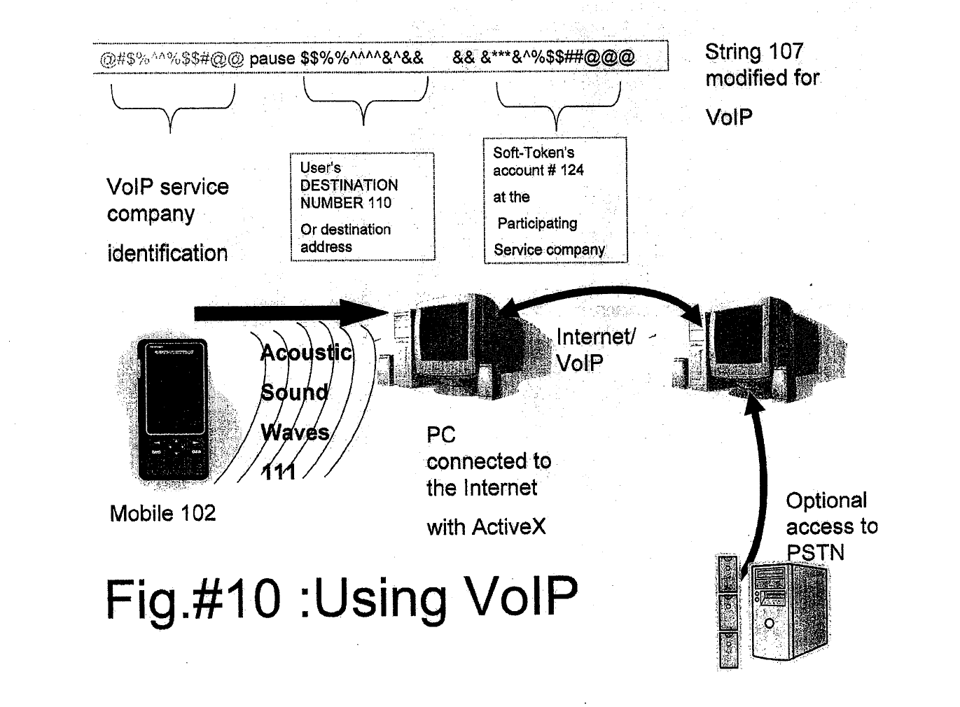

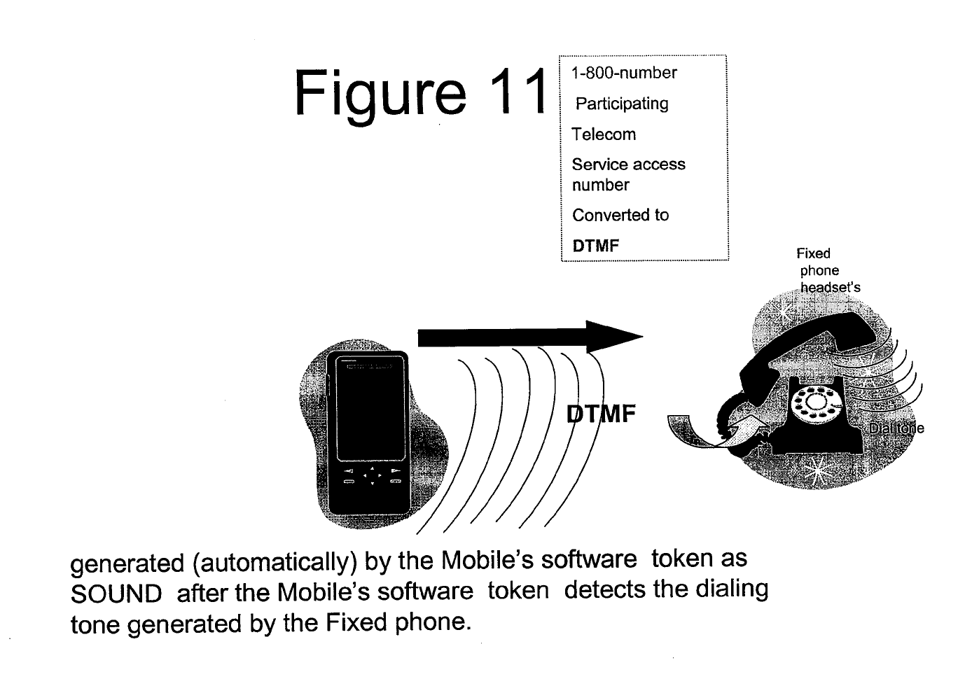

### DETAILED DESCRIPTION

The present invention may be described herein in terms of various functional components and various processing steps. It should be appreciated that such functional components may be realized by any number of hardware or structural components configured to perform the specified functions. For example, the present invention may employ various integrated components, such as transistors, amplifiers, buffers, and logic devices comprised of various electrical devices, e.g., resistors, capacitors, diodes and the like, whose values may be suitably configured for various intended purposes. Further, it should be noted that while various components may be suitably coupled or connected to other components within exemplary circuits, such connections and couplings can be realized by direct connection between components, or by connection through other components and devices located thereinbetween.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

If a given Service Company, which is referred to in the following as a Participating

Telecom Service Company 109, or Service Company 109, decides to adopt and market the present invention, Service Company 109 may bring to the market methods and system to set up calls using mobiles 102. In accordance with various embodiments of the present invention, such methods and system will not use the mobile network 129 of any cellular operator 130, but instead will use the wired network, also referred as PSTN 116 of a fixed phone local Telecom Com 115.

In order to better clarify various methods of the present invention, we will describe summarily the steps carried on by the user 101, application 100 and system 123 for various exemplary embodiments of the present invention.

First embodiment 132: mobile 102, generates the access number 119 encoded to DTMF. Access number 119 is captured and transmitted by the fixed phone 104. Mobile 102, by utilizing application 100, encodes to sound the user's login number 108, the application PIN 135 (if any), and according to the particular circumstance, the destination number 110, or the nickname 137 of the destination, or any other information in order to enable the system 123 to retrieve the user's destination number 110 from the database 123.

The system 123 is placed in “voice-contact” with mobile 102, through fixed phone 104. System 123 receives the encoded version of the information 142 (i.e., soft-Token identification 124 and user destination number 110) and decodes the information to recuperate the soft-token's or user's account 124 as well as the user destination number 110.

Having determined the specific user's account 124, system 123 checks account 124 to determine whether or not to enable the setting up of outgoing call 126. If system 123 enables the outgoing call 126, the system 123 dials the destination number 110 and conferences both calls, the incoming call 127 and the outgoing call 126. System 123 may monitor the call evolution and limit it according to selected commercial criteria.

2nd Embodiment 136: Digital Signature

Another exemplary embodiment 136 of the present invention may comprise an application 100 which computes string 107 in a different way. In accordance with this exemplary embodiment, the first portion 113 is similar as discussed above in accordance with the first embodiment. However, the 2^{nd} of the string 107 has the destination number 110 or nickname 137, digitally signed by the application 100.

Stated another way, mobile 102, transmits the access number 119 encoded to DTMF through fixed phone 104. Mobile 102, by utilizing application 100, encodes to sound the user's digital signature applied, optionally according with the case, to one or more of the following: the PIN 135; the time and date; the destination number 110; the nickname 137 of the destination; any other information in order to enable system 123 to retrieve the destination number from database 123; or to the conversation time limit (if any).

System 123, once in voice-contact with mobile 102 through the fixed phone 104, receives the digitally signed data as an encoded version of the information and decodes it.

The signed string may include the open information, the signed hash value of the information, and the X.509 or just the X.509 serial number. Having received this signed string, the system according to the case, may retrieve the X.509 certificate from the database 122. Once the X.509 is available, system 123 may extract information about the user ID, and the user's public key from the X.509 certificate. With the Public key, system 123 may decrypt the received encrypted hash value and compare the value with the computed open information's hash value. If both Hash values are identical, the user is identified and the content of the digital signature cannot later be repudiated by a third party.

Having determined the specific user's account 124, system 123 checks account 124 to determine whether or not to enable the setting up of outgoing call 126. If system 123 enables the outgoing call 126, the system 123 dials the destination number 110 and conferences both calls, the incoming call 127 and the outgoing call 126. System 123 may monitor the call evolution and limit it according to selected commercial criteria and the credit status 125 of account 124.

3rd Embodiment 138: with Time-limit

In accordance with another exemplary embodiment 138 of the present invention, string 107 may include the amount of credit, or of minutes (Conversation Time Limitation 140) selected by the user, or pre-established for that particular soft-token.

In accordance with this exemplary embodiment, mobile 102, transmits the access number 119 encoded to DTMF through fixed phone 104 to the switch 117. Mobile 102, by utilizing application 100, encodes to sound the user's login number 108, the application PIN 135 (if any), or the token/user account 124 according with the case, and the destination number 110, or the nickname 137 of the destination, or any other information in order to enable the system 123 to retrieve the destination number from the databases 122. Optionally, the conversation time limit 140 entered by the user 101, or pre-set in the application 100, or by default, is also included if present.

System 123, once in “voice-contact” with mobile 102, through the fixed phone 104, receives the encoded version of the information 142 and decodes the information.

Having determined the specific user's account 124, system 123 checks account 124 to determine whether or not to enable the setting up of outgoing call 126. If system 123 enables the outgoing call 126, the system 123 dials the destination number 110 and conferences both calls, the incoming call 127 and the outgoing call 126. System 123 may monitor the call evolution and limit it according to selected commercial criteria and/or to a received time limit 140.

4^{th} Embodiment 139—Anonymous Soft-Token

In accordance with a further exemplary embodiment 139 of the present invention, an “Anonymous Soft-token” 143 with rights to sustain one or more conversations for a limited time or a limited amount of money 140 is utilized. In accordance with this exemplary embodiment, there is no user's identification or determination of user's account 124. Rather, system 123 receives information about the soft-token identification and then retrieves the soft-token account 124.

The user receives/download the soft-token 100 which, in accordance with this exemplary embodiment 139, includes a soft-token's serial number or soft-token's account number 124 or the Soft-token's Conversation Time Limit, which may be associated with a determined amount of money or any other accounting equivalent.

When the user of the soft-token/application 100 launches application 100, they are prompted for the destination number 110, which may be retrieved from the mobile phone book, or entered by the user 101 into the mobile, or vocally recited by the user 101 for the system 123 which may interpret the number 110 using speech recognition technologies.

As described above for other exemplary embodiments, the system 123 is placed into “voice-contact” with the mobile 102, through the fixed phone 104.

In accordance with this exemplary embodiment 139, mobile 102, transmits the access number 119 encoded to DTMF through fixed phone 104. Mobile 102, by utilizing application 100, encodes to sound the soft-token identification info, and according with the case, the destination number 110, or the nickname 137 of the destination entered by the user, or any other information in order to enable the system 123 to determine the destination number.

Having determined the specific soft-token 100, system 123 determines whether or not to enable the setting up of the outgoing call 126. If system 123 enables the outgoing call 126, the system 123 dials the destination number 110 and conferences both calls, the incoming call 127 and the outgoing call 126. System 123 may monitor the call evolution and limit it according to the received data and to selected commercial criteria.

Alternative Embodiment: “Pre-signed Soft-Token”

In accordance with another exemplary embodiment of the present invention, a soft-token 100 includes certain data which it is digitally signed by the participating telecom 109 or by any other related commercial entity, in a way such that system 123 may check the authenticity of the signed data transmitted by the soft-token 100. In accordance with this exemplary embodiment, system 123 may authenticate the signed data by checking the validity of the participating telecom 109 signature. The digitally signed data may include one or more of the soft-token id/serial number and the soft-token rights (i.e., amount of minutes, money, or equivalent).

In accordance with this exemplary embodiment, soft-token 100 forms the string that includes the destination number 110 and the soft-token's account number 124, which is pre-digitally signed or secured by the Participating Telecom 109. User 101 places mobile 102 proximate to the fixed phone headset's microphone 148 or to the hands-free microphone 148 and further activates the application 100. Alternatively, in accordance with this exemplary embodiment, soft-token 100 activates itself when soft-token 100 “hears/detect” the fixed phone 104 dialing tone. Soft-token 100 encodes the service company access number 119 to DTMF and such sound waves are captured by microphone 148 and converted to electrical waves which are transmitted by the local telephone network, or PSTN 116 to the closest switch 117.

Switch 117 decodes the “electrical” DTMF and sets up the call to the participating service company's PBX 120 which is part of the service company system 123.

In accordance with this exemplary embodiment, system 123 receives data including the user's destination number 110 and the soft-token's account number 124. These items may have been digitally signed by the participating telecom 109. If this is the case, system 123 verifies the validity of the digital signature.

Eventually, system 123 sets up the outgoing call 126 that enables user 101 to speak with his destination number 110 for a pre-specified amount time 140 or amount of money 145, or any other equivalent limitation.

In accordance with another aspect of the present invention, one further variation which may be applied to the various exemplary embodiments is where system 123, when reached, returns with a special “tone” signal, referred to as a Triggering Tone, to the user 101 or to the mobile application 100. The Triggering Tone signifies that system 123 is ready to receive and decode the rest of the encoded string 142 including all the sound waves after the first part, which carries the service company number. That is, the sound waves carrying, inter alia, the indicia about the account or the destination number or both.

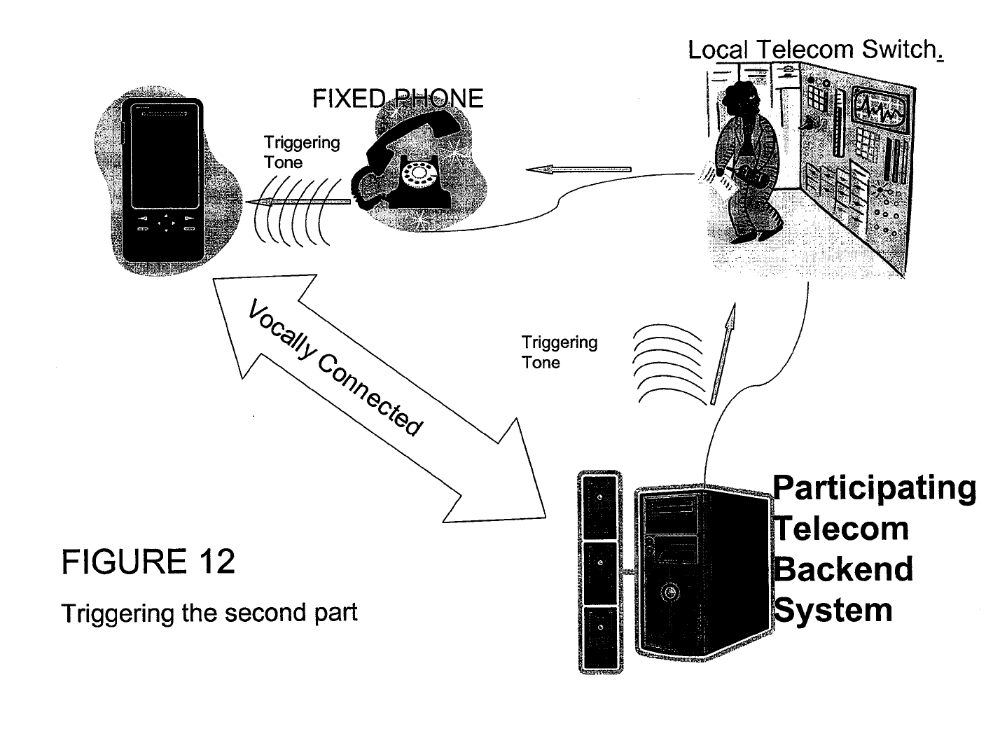

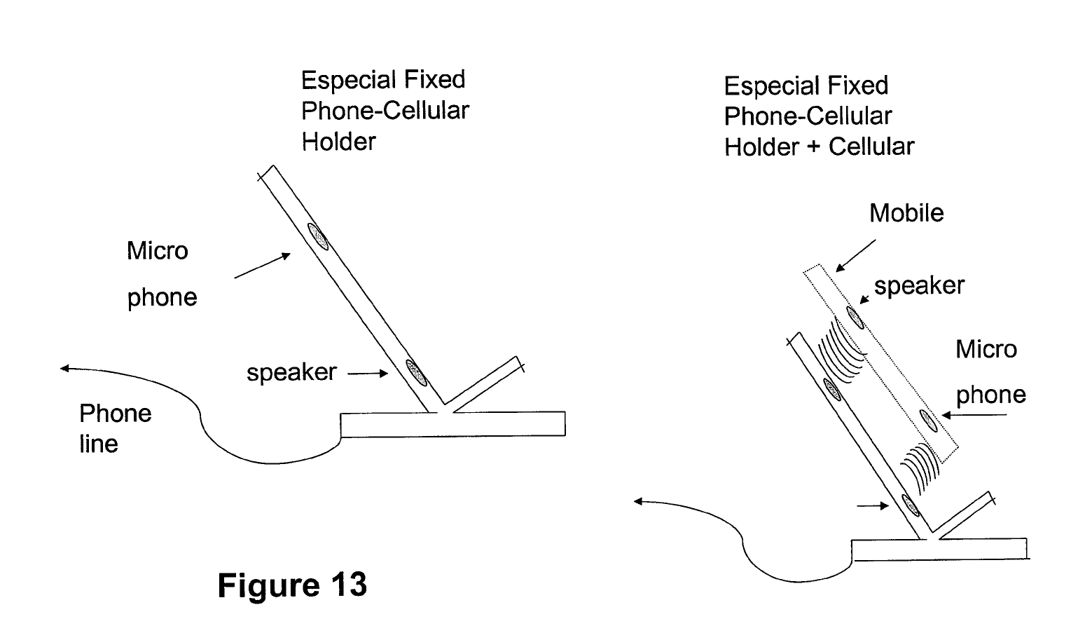

In accordance with this aspect of the present invention, with reference to FIG. 12, soft-token 100, after capturing the special “tone” or Triggering Tone generated by system 123, sends the rest of encoded string 111 (i.e., the rest of the string 107 encoded to sound).

Therefore, the “pause” will continue until soft-token 100 captures the Triggering tone or, until after the pushing of a given key by the user 101 following the detection by the user of the Triggering tone generated by the system.

5^{th} Embodiment Referred to as Dedicated Number Soft-Token 144.

In accordance with another exemplary embodiment of the present invention, a Dedicated Destination Number soft-token 144 comprises soft-token 100 in which the conversation destination phone number 110 is pre-embedded. For example, a given person such as a parent buys a soft-token 144. In accordance with this exemplary embodiment, soft-token 144 may comprise one of the various embodiments of the application 100 that is marketed or delivered by participating service company 109 in which the pre-specified user's destination number is pre-stored in the soft-token 100 (i.e., the phone number of the parent of the caller (the parent's number)). This soft-token can be an open credit token or may be limited to a given amount of money 145 (i.e., Pre-Paid Acoustic Dedicated soft-token). The parent purchases the token and sends token to his child, via, for example, SMS message. The child, having received and installed the Dedicated Destination Number soft-token 144, may place calls only to her parent, with this soft-token, until the pre-paid amount 145 is exhausted, or until the pre-specified number of minutes 140 are used, or by using the soft-token credit line financed by the parent.

It will be appreciated that the parent-child case is just an example of one of the possible pairings and that the same concept of dedicated number soft-token may be applied to other pairing such as a Store-Potential Customer pair. In accordance with this exemplary embodiment, the store sends the dedicated number soft-token 144 to a customer, by, for example, SMS, to enable, for example, an overseas customer, to call the store using the store account from any corner of the globe.

In accordance with this exemplary embodiment of the present invention, the soft-token may be configured to a particular country, such as the particular international call characteristics for that country, or alternatively, the user (store's customer) may select the county that is of interest.

Alternatively, in accordance with another exemplary embodiment of the present invention soft-token 100 forms a string 107 that includes only the user's destination number 110. This string may be encoded to DTMF by the soft-token 100. In accordance with this exemplary embodiment, the call is not necessarily charged to the soft-token 100 owner or to the soft-token account. The switch 117 sets up the call to the received user's destination number 110 and it is not necessary to utilize a participating service company 109. Instead, token 100 can be a feature of the cell phone 102 or may be used as an advertising tool. That is, token 100 announces/displays a message on behalf of a given entity.

Various embodiments of the present invention may include apparatus for performing the operations described here. In accordance with various embodiments of the present invention, one possible usage may comprise the use of specially designed fixed phone sets 146 that are to be used with the Cell phone 102 in which the soft-token 100 is installed. These specially designed fixed phone sets 146 have no dialing buttons, and in fact practically no mechanical parts, other than a speaker and a microphone 148. Once soft-token 100 generates the encoded version of the string 107, the microphone 148 of the specially designed fixed phone set 146 will capture the encoded string and since phone 146 is connected to the PSTN, the encoded information is transmitted to the nearest switch 117. Thus, caller 101 will be able to speak with his destination number.

It will be appreciated that the manufacturing and installation of such specially designed fixed phone sets 146, due to their simplicity, may be very inexpensive, resulting in a convenient and secure public phone service, where no coins or cash are necessary and, simultaneously the access to the service can be restricted to authorized users only. That is, people that have acquired the application 100.

Unless specifically stated otherwise, it is appreciated that, throughout the specification, terms such as “processing,” “computing,” “calculating,” “determining”, “acoustic”, “encoding” or the like, refer sometimes to the action and/or processes of a mobile phone's computing system, or to other similar electronic computing device, such as any hand-held device that manipulates and/or transforms data, such as electronic data. Such actions may include quantities within a computing system's registers and/or memories into other data similarly representing quantities within a cell phone computing system's memories, registers or other such information storage, transmission or display tools.

Various embodiments of the present invention may include apparatus for performing the operations described herein. This apparatus may be specially constructed for the desired purposes, or it may comprise a general-purpose cell phone or mobile phone, or any other hand-held device with computer capabilities. The soft-token may be stored in the mobile device's readable storage medium, such as, but not limited to, any type of SIM card, disk, including optical disks, electrically erasable and programmable read only memories (EEPROMs), magnetic or optical cards, Flash memory, or any other type of media suitable for storing electronic instructions and capable of being coupled to a the mobile CPU system.

The processes and displays presented herein are not inherently related to any particular mobile or other apparatus. Various general-purpose systems may be used with soft-tokens 100 in accordance with the teachings herein, or it may prove convenient to use, instead of cell phones 102, devices such as Palms, Pocket PCs, Blackberries or the like, or to construct a more specialized apparatus to perform the desired method. In addition, various embodiments of the present invention are not described with reference to any particular programming language or operation system. It will be appreciated that a variety of programming languages may be used to implement the teachings of the present invention as described herein.

Also, it should be appreciated that user's destinations number 110 may comprise cell phones numbers as well as VoIP destinations/addresses, and thus is not limited to fixed-line phone numbers

An additional variation 147 of the present invention presented here is that instead of the fixed-line phones 104 usage, PCs are utilized that communicate with VoIP, and through the internet to the PSTN.

One of the possible exemplary embodiments of this VoIP variation 147 includes the installation on the PC, of an ActiveX module able to capture the acoustic information 111 generated by the soft-token 100, and to decode the acoustic information to recover the string 107. Then, the ActiveX can pass to a system such as Skype, for example, the necessary information to set-up a call to a PC or to a phone. Thus all of the embodiments presented here can be modified according to this variation.

Naturally, the string 107 for VoIP 147 variation includes the Service Company 1D in certain cases, and may also include the destination address in order to reach a possible destination target which is a PC in the internet.

Reference is made to FIG. 10 which shows one possible embodiment using VoIP/internet network/with optional access to the PSTN.

The distribution of soft-tokens 100 which represent free/limited access tools to the PSTN or Internet/VoIP networks may support marketing operations and advertising campaigns.

Nevertheless, the soft-token 100 concept may also represent a personal tool for asking a given party to call-back. That is, an SMS with the soft-token 100 in the Dedicated Destination Number embodiment can send to such a party, wherein the party installs it in his cell phone 102 and calls the sender on the sender account, constituting a person to person calling tool.

While we referred here to the acoustic transmission of the string 107 in exemplary embodiments of the present invention, other transmission means such as IR, Bluetooth, Wi-Fi, or the like may be used when convenient, especially when communicating with a PC.

The present invention has been described above with reference to various exemplary embodiments. However, those skilled in the art will recognize that changes and modifications may be made to the exemplary embodiments without departing from the scope of the present invention. For example, the various exemplary embodiments can be implemented with other types of telephones or communication devices in addition to the telephones illustrated above. These alternatives can be suitably selected depending upon the particular application or in consideration of any number of factors associated with the operation of the system. Moreover, these and other changes or modifications are intended to be included within the scope of the present invention.

What is claimed is:

1. A system comprising:
a mobile communicator having communication software configured to encode to sound waves a destination number; and
a fixed line telephone having a microphone configured to capture the encoded sound waves.

2. The system of claim 1, wherein the communication software is further configured to encode to sound waves a participating telecom company service number and an indicia of an account number.

3. The system of claim 1, wherein the fixed line telephone comprises a personal computer having a microphone.

4. A computer-implemented method of communicating comprising:
using a mobile communicator to set up a phone call;
using a fixed line phone for communication during the phone call;
encoding a destination number to sound waves; and
capturing, by a microphone of the fixed line phone, the encoded sound waves.

5. The computer-implemented method of claim 4, further comprising:
encoding a participating telecom company service number to sound waves; and
encoding an indicia of an account number to sound waves.

6. The computer-implemented method of claim 4, wherein the step of capturing comprises capturing by a microphone of a personal computer.

7. The computer-implemented method of claim 4, further comprising the steps of capturing a dial tone generated by the fixed line phone; and using the capturing of the dial tone to trigger the step of encoding a destination number to sound waves.

8. The computer-implemented method of claim 5, further comprising the steps of capturing a trigger tone generated by the participating telecom company; and using the capturing of the trigger tone to trigger the steps of encoding a participating telecom company service number and encoding an indicia of an account number to sound waves.
